(19) United States
(12) Patent Application Publication
(10) Pub. No.: US 2026/0105356 A1
(43) Pub. Date: Apr. 16, 2026

(54) COMPUTER-BASED SYSTEMS CONFIGURED FOR MAKING DECISIONS IN DIVERSE SITUATIONS AND METHODS OF USE THEREOF

(71) Applicant: Capital One Services, LLC, McLean, VA (US)

(72) Inventors: Matthew Louis Nowak, Midlothian, VA (US); Robert Dwane Wokaty, JR., Glen Allen, VA (US); Taylor Turner, Richmond, VA (US); David Crawford, McLean, VA (US)

(21) Appl. No.: 18/916,381

(22) Filed: Oct. 15, 2024

(51) Int. Cl. G06N 20/00; H04L 41/16

(52) U.S. Cl. CPC G06N 20/00; H04L 41/16

(57) ABSTRACT

A server executed method includes distributing a first ML model to a first and second edge device, wherein the first and second edge device train the first ML model, respectively, with a first and second dataset, updating the first ML model to generate a first updated ML model, distributing the first updated ML model to the first and second edge device to replace the first and second edge ML model executed respectively in the first and second edge device, designating a memory space to store a first and second value associated with the first and second edge device, respectively, wherein the first and second value are determined by the server utilizing the first updated ML model based on the first and second dataset, respectively, and the first value is different from the second value, and instructing the first and second edge device to present the first and second value, respectively.

### FIELD OF TECHNOLOGY

The present disclosure generally relates to computer-based decision making systems and methods, and more particularly to computer-based systems configured for dynamically making discrete decisions in diverse situations and methods of use thereof.

### BACKGROUND OF TECHNOLOGY

Typically, one may consider Artificial Intelligence (AI) to be a branch of computer science that focuses on creating technology capable of performing tasks that typically require human intelligence. These tasks may include problem-solving, decision-making, and learning.

Typically, AI technologies may include machine learning, where algorithms learn from data to make predictions or decisions, and deep learning, which involves neural networks with many layers that can recognize patterns in data.
Typically, AI technologies may make predictions by analyzing large amounts of data and identifying patterns that may not be immediately apparent to humans.

In some instances, there may be situations where predictions and/or decisions need to be made based on individual cases, yet individual predictions and/or decisions may affect each other. As such, it may be desirable to have an AI system and method for making predictions and/or decisions in diverse situations.

### SUMMARY OF DESCRIBED SUBJECT MATTER

In some aspects, the techniques described herein relate to a computer-implemented method, including: distributing, by a central server, a first machine learning model to a first and second edge computing device, where the first edge computing device trains the first machine learning model with a first dataset collected by the first edge computing device to generate a first edge machine learning model, and the second edge computing device trains the first machine learning model with a second dataset collected by the second edge computing device to generate a second edge machine learning model; updating, by the central server aggregating with at least one weight matrix reflecting the first and second edge machine learning model, the first machine learning model to generate a first updated machine learning model; distributing, by the central server, for further training, the first updated machine learning model to the first and second edge computing device to replace the first and second edge machine learning model executed respectively in the first and second edge computing device; designating, by the central server, a memory space in the central server associated with the first and second edge computing device to store a first and second value associated with the first and second edge computing device, respectively, where the first and second value are determined by the central server utilizing the first updated machine learning model based on the first and second dataset, respectively, and the first value is different from the second value; and instructing, by the central server, the first and second edge computing device to present the first and second value, respectively.

In some aspects, the techniques described herein relate to a method, where the first dataset is stored in the first edge computing device and the second dataset is stored in the second edge computing device.

In some aspects, the techniques described herein relate to a method, where the first and second dataset have the same features.

In some aspects, the techniques described herein relate to a method, where the features include spend history, bureau report and reward usage of a user of the first or second edge computing device.

In some aspects, the techniques described herein relate to a method, where the first edge computing device is associated with at least one first hyperparameter used for training the first machine learning model to generate the first edge machine learning model, and the second edge computing device is associated with at least one second hyperparameter different from the at least one first hyperparameter for training the first machine learning model to generate the second edge machine learning model.

In some aspects, the techniques described herein relate to a method, where the first machine learning model is updated at a predetermined frequency.

In some aspects, the techniques described herein relate to a method, where the first edge computing device collects a third dataset after presenting the first value and further trains the first updated machine learning model with the third dataset.

In some aspects, the techniques described herein relate to a method, further including condensing the first updated machine learning model before distributing the first updated machine learning model.

In some aspects, the techniques described herein relate to a method, where the first and second edge machine learning model are weighted equally.

In some aspects, the techniques described herein relate to a method, where the first and second edge machine learning model are weighted differently based on attributes associated with the first and second edge computing device.

In some aspects, the techniques described herein relate to a computer-implemented method, including: distributing, by a central server, a first machine learning model to a first and second edge computing device, where the first edge computing device trains the first machine learning model with a first dataset stored in the first edge computing device to generate a first edge machine learning model, and the second edge computing device trains the first machine learning model with a second dataset stored in the second edge computing device to generate a second edge machine learning model, where the first and second dataset have same features; updating, by the central server aggregating with at least one weight matrix reflecting the first and second edge machine learning model, the first machine learning model to generate a first updated machine learning model; distributing, by the central server, for further training, the first updated machine learning model to the first and second edge computing device to replace the first and second edge machine learning model executed respectively in the first and second edge computing device; designating, by the central server, a memory space in the central server associated with the first and second edge computing device to store a first and second value associated with the first and second edge computing device, respectively, where the first and second value are determined by the central server utilizing the first updated machine learning model based on the first and second dataset, respectively, and the first value is different from the second value; and instructing, by the central server, the first and second edge computing device to present the first and second value, respectively.

In some aspects, the techniques described herein relate to a method, where the first edge computing device is associated with at least one first hyperparameter used for training the first machine learning model to generate the first edge machine learning model, and the second edge computing device is associated with at least one second hyperparameter different from the at least one first hyperparameter for training the first machine learning model to generate the second edge machine learning model.

In some aspects, the techniques described herein relate to a method, further including condensing the first updated machine learning model before distributing the first updated machine learning model.

In some aspects, the techniques described herein relate to a system, including: at least one central server; and at least one memory storing a plurality of computing instructions configured to instruct the at least one central server to: distribute a first machine learning model to a first and second edge computing device, where the first edge computing device trains the first machine learning model with a first dataset collected by the first edge computing device to generate a first edge machine learning model, and the second edge computing device trains the first machine learning model with a second dataset collected by the second edge computing device to generate a second edge machine learning model; update, by aggregating with at least one weight matrix reflecting the first and second edge machine learning model, the first machine learning model to generate a first updated machine learning model; distribute, for further training, the first updated machine learning model to the first and second edge computing device to replace the first and second edge machine learning model executed respectively in the first and second edge computing device; designate a memory space in the central server associated with the first and second edge computing device to store a first and second value associated with the first and second edge computing device, respectively, where the first and second value are determined by the central server utilizing the first updated machine learning model based on the first and second dataset, respectively, and the first value is different from the second value; and instruct the first and second edge computing device to present the first and second value, respectively.

In some aspects, the techniques described herein relate to a system, where the first dataset is stored in the first edge computing device and the second dataset is stored in the second edge computing device.

In some aspects, the techniques described herein relate to a system, where the first and second dataset have the same features.

In some aspects, the techniques described herein relate to a system, where the first edge computing device is associated with at least one first hyperparameter used for training the first machine learning model to generate the first edge machine learning model, and the second edge computing device is associated with at least one second hyperparameter different from the at least one first hyperparameter for training the first machine learning model to generate the second edge machine learning model.

In some aspects, the techniques described herein relate to a system, where the first machine learning model is updated at a predetermined frequency.

In some aspects, the techniques described herein relate to a system, where the plurality of computing instructions are further configured to instruct the at least one central server to condense the first updated machine learning model before distributing the first updated machine learning model.

In some aspects, the techniques described herein relate to a system, where the first and second edge machine learning model are weighted equally.

### BRIEF DESCRIPTION OF THE DRAWINGS

Various embodiments of the present disclosure can be further explained with reference to the attached drawings, where like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 is a block diagram illustrating an exemplary computer network in accordance with at least some embodiments of the present disclosure.

FIG. 2 is a block diagram illustrating a distributed artificial intelligence (AI) based decision-making system in accordance with at least some embodiments of the present disclosure.

FIG. 3 is a block diagram illustrating another distributed artificial intelligence (AI) based decision-making system in accordance with at least some embodiments of the present disclosure.

FIG. 4 is a block diagram illustrating an AI-based banking system for making discrete decisions catered to individual customers in accordance with at least some embodiments of the present disclosure.

FIG. 5 is a flowchart illustrating an exemplary process for making discrete decisions for individual edge computing devices in accordance with at least some embodiments of the present disclosure.

FIG. 6 is a block diagram of a computing system for implementing the processes depicted in FIG. 1 - 5 in accordance with at least some embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

In at least some embodiments, the present disclosure is directed to an exemplary method for invisibly authenticating a bank account access request.

In at least some embodiments, the present disclosure may be directed to addressing a technological problem with an artificial intelligence (AI) based system for making discrete decisions by a central server for diverse edge computing devices.

At least some embodiments of the present disclosure herein describe a server executed method including distributing a first machine learning model to a first and second edge device, where the first and second edge device train the first machine learning model, respectively, with a first and second dataset; updating the first machine learning model to generate a first updated machine learning model; distributing the first updated machine learning model to the first and second edge device to replace the first and second edge machine learning model executed respectively in the first and second edge device; designating a memory space to store a first and second value associated with the first and second edge device, respectively, where the first and second value are determined by the server utilizing the first updated machine learning model based on the first and second dataset, respectively, and the first value may be different from the second value; and instructing the first and second edge device to present the first and second value, respectively.

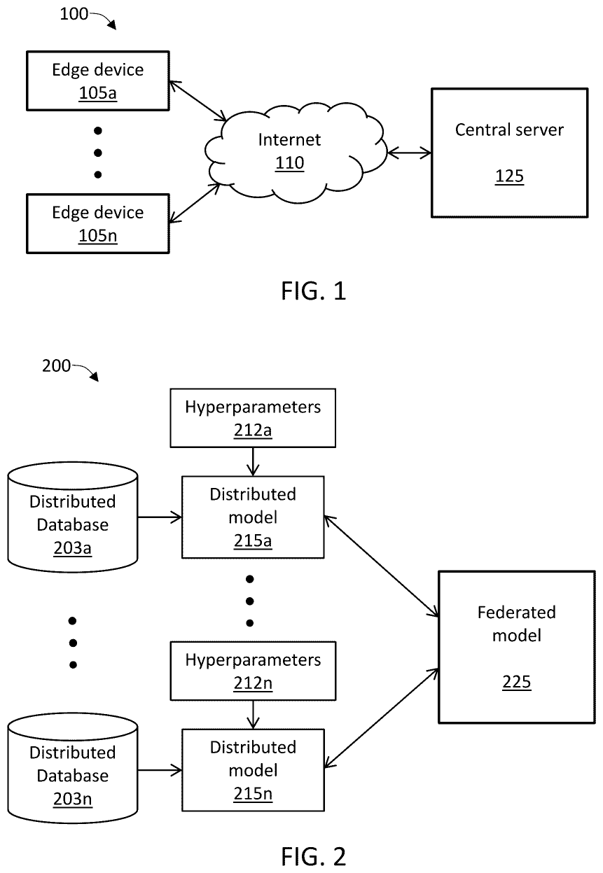

FIG. 1 is a block diagram illustrating an exemplary computer network 100 in accordance with at least some embodiments of the present disclosure. The computer network 100 includes a plurality of edge computing devices 105a-105n coupled to a central server 125 through the Internet 110. The edge computing devices 105a-105n sit at the periphery of the computer network 100 and link the computer network 100 to other networks and the physical world. On the other hand, the central server 125 may be where the edge computing devices 105a-105n are connected to a network to deliver data and receive instructions.

In some embodiments, the edge computing devices 105a-105n may exemplarily be smartphones or personal computers (PCs) belonging to individual customers of a bank which runs the central server 125 in a data center or the cloud. The smartphones or PCs may run banking applications in communication with the bank's central server. In some embodiments, the smartphones or PCs as the edge computing devices 105a-105n may be equipped for machine learning, advanced processing and decision-making. In some other embodiments, the edge computing device 105a-105n may exemplarily be point-of-sale (POS) devices of merchants running a banking application in communication with the central server 125 of the bank. In some embodiments, the POS devices as the edge computing devices 105a-105n may be equipped for machine learning, advanced processing and decision-making.

With the advent of edge computing devices 105a-105n, data-related processes can occur locally on the edge computing devices 105a-105n, bringing processing closer to the device that generates data. This reduces the need for data to travel to the central server 125 for processing, thereby minimizing latency, bandwidth and data security issues. When data needs to be processed in the central server 125, only the most important data may be transmitted. The edge computing devices 105a-105n and the central server 125 work together to ensure efficient data processing and transmission.

FIG. 2 is a block diagram illustrating a distributed artificial intelligence (AI) based decision-making system 200 in accordance with at least some embodiments of the present disclosure. The AI-based decision-making system 200 includes a plurality of distributed AI models 215a-215n, a plurality of sets of hyperparameters 212a-212n, a plurality of distributed databases 203a-203n and a federated AI model 225. Each of the plurality of sets of hyperparameters 212a-212n may be associated with one of the plurality of distributed AI models 215a-215n. For example, hyperparameters 212a may be associated with distributed AI model 215a as shown in FIG. 2. Each of the plurality of databases 203a-203n may be dedicated to train one of the plurality of distributed AI modes 215a-215n. For example, datasets stored in the distributed database 203a may be used to train distributed AI model 215a and datasets stored in the distributed database 203n may be used to train distributed AI model 215n as shown in FIG. 2. In some embodiments, the datasets stored in the distributed databases 203a-203n have the same features. In some embodiments, the federated AI model 225 may be created by an aggregation method with a weight matrix from the distributed models 215a-215n. The weight matrix can be used to determine the contribution of each distributed model 215a-215n to the federated AI model 225. The weights in this matrix may be determined based on the performance of each distributed model 215a-215n. In some embodiments, the distributed edge devices 105a-105n may be weighted equally. In some other embodiments, the distributed edge device 105a-105n may be weighted differently based on other attributes of the customers using the edge devices 105a-105n.

For instance, a distributed model 215a-215n that performs better on a holdout dataset may be given more weight in the aggregation. This means that its predictions will have a greater influence on the final output. In an exemplary neural network, the weight matrix may be calculated during the training process. The weights are initially set to random values and then iteratively adjusted in response to the error the model makes on the training data. The adjustment may be done using an optimization algorithm like gradient descent, where the weights are updated in the direction that minimally reduces the error.

In some embodiments, creating the federated model 225 from the distributed models 215a-215n may involve following exemplary steps:
Choose a suitable machine learning model based on the problem the system may be trying to solve.
Decide how the edge devices 105a-105n will communicate with the central server 125.
Build a centralized service which will coordinate the training process, aggregate the model updates from the edge devices 105a-105n, and distribute the updated global model 225.
Set up the training process. The training process involves training local models on each edge device 105a-105n, sending the updates to the central server 125, aggregating the updates, and distributing the updated global model.
Establish a model management system to manage the lifecycle of the models, including versioning and deployment.
Addressing privacy and security. Federated learning may involve sensitive data on the edge devices 105a-105n, so at least some embodiments of the present disclosure are programmed to implement measures to protect privacy and ensure security.

In some embodiments, the federated AI model creation process may involve condensing down a customer's history and attributes collected on the edge computing devices 105a-105n into some profiles which resembles a summary of the customer data. By embedding the profiles in an embedding space to get some nuanced training data to then potentially get more accurate data.

In some embodiments, once the federated AI model is up and running, it may not be executed on the central server 125, but distributed to the edge devices 105a-105n for execution. Then the distributed AI model must be condensed, requiring less data and smaller than the model running on the central server 125.

In some embodiments, the distributed AI models 215a-215n and the federated AI model 225 are programs or algorithms that enable machines to analyze data, identify patterns, and make predictions. By learning from their experiences, AI models can adapt to new situations and make corresponding new predictions.

In some embodiments, the distributed models 215a-215n may be small ones condensed from the federated model 225, so that the models 215a-215n can run on the edge devices 105a-105n.

AI models apply different algorithms to relevant data inputs to achieve the tasks, or output, they've been programmed for. They are defined by their ability to autonomously make decisions or predictions, rather than simulate human intelligence. Different types of AI models are better suited for specific tasks, or domains, for which their particular decision-making logic may be most useful or relevant.

AI models can automate decision-making, but only models capable of machine learning (ML) are able to autonomously optimize their performance over time. ML models use statistical AI, and are “trained” by applying their mathematical frameworks to a sample dataset whose data points serve as the basis for the model's future real-world predictions.

In some embodiments, each of the plurality of AI models 215a-215n may be an autonomous learning processing node and can make decisions independently. Each of the plurality of AI models 215a-215n may be trained by data from one or more dedicated databases 203a-203n. For example, database 203a may be dedicated to train AI model 215a; and database 203n may be dedicated to train AI model 215n.

In some embodiments, once the distributed AI models 215a-215n are trained on local data samples, parameters (e.g., the weights and biases of a deep neural network) of models 215a-215n may be exchanged between the distributed notes at a predetermined frequency to generate the federated model 225 which may then be shared by all the nodes. For example, the distributed models 215a-215n may all come from the federated model 225. As new data may be provided from the databases 203a-203n, the distributed models 215a-215n may be re-trained with the new data. After a set time period, parameters from the retrained distributed models 215a-215n are used to regenerate the federated model 225 which may then replace the distributed models 215a-215n for making predictions as well as being further trained.

In some embodiments, the hyperparameters 212a-212n are configuration variables that are external to the models 215a-215n and whose value cannot be estimated from data. They are often used in processes to help estimate model parameters. Hyperparameter tuning may be a process of selecting the optimal values for hyperparameters of the machine learning model. The values are determined after iterating through different combinations of hyperparameter values with a model and comparing the metrics/evaluation results.

Below are exemplary steps for tuning the hyperparameters 212a-212n:
Select the right type of model: Different models have different hyperparameters. For example, a decision tree has hyperparameters like max_depth, min_samples_split, etc., while a neural network might have learning rate, number of layers, number of units per layer, etc.
Review the list of parameters of the model and build the hyperparameter space: This involves identifying which hyperparameters are relevant to the model and specifying a range or a set of values for each of them to explore.
Finding the methods for searching the hyperparameter space: There are several methods for this, including Grid Search, Random Search, Bayesian Optimization, and others. Grid Search exhaustively tries every combination of hyperparameters, while Random Search randomly selects combinations to try.
Applying the cross-validation scheme approach: This involves splitting the dataset into a training set and a validation set. The model may be trained on the training set with a given combination of hyperparameters, and its performance may be evaluated on the validation set. This process may be repeated for each combination of hyperparameters.
Assess the model score to evaluate the model: After training and validating the model with all combinations of hyperparameters, the combination that gave the best performance on the validation set may be chosen as the optimal set of hyperparameters.

A goal of hyperparameter tuning may be to find the hyperparameters that yield the most accurate model. It may be crucial for building effective models 215a-215n.

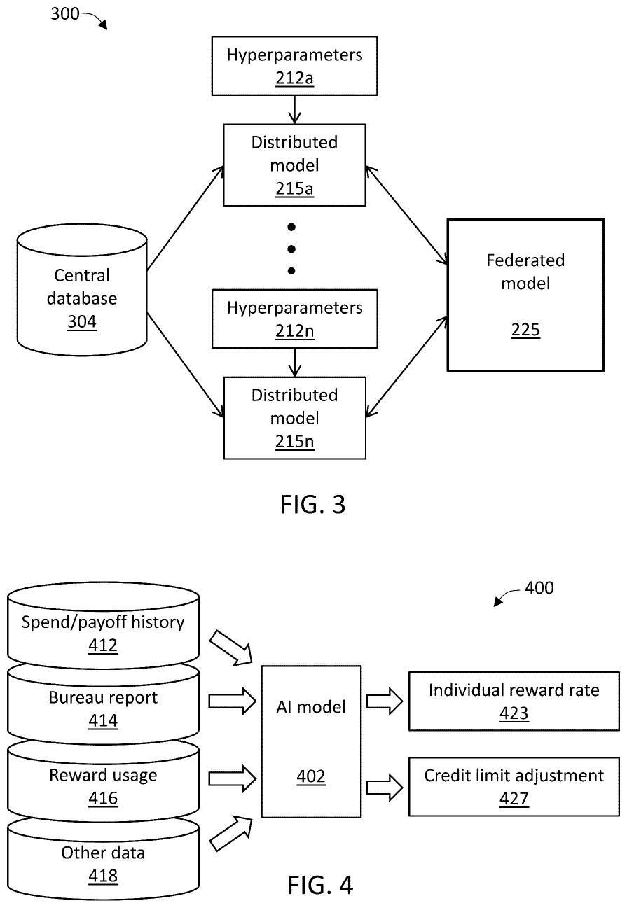

FIG. 3 is a block diagram illustrating another distributed artificial intelligence (AI) based decision-making system 300 in accordance with at least some embodiments of the present disclosure. The system 300 is different from the system 200 in that a central database 304 of system 300 has collected all the training data from the distributed databases 203a-203n and provides the training data to the distributed models 215a-215n as shown in FIG. 3. In some embodiments, the database 304, the distributed models 215a-215n and the federated model 225 may reside in the central server 125.

In some embodiments, the distributed AI models 215a-215n may be responsible for training on discrete datasets collected from the edge devices 105a-105n in either distributed databases 203a-203n or central database 304; and the federated AI model 225 may be responsible for making individual decisions based on the discrete datasets. The individual decisions are then provided to the corresponding edge devices 105a-105n.

In some embodiments, the systems shown in FIGS. 1-3 may be applied by financial institutions such as a bank. The central server 125 may be run by the bank and the edge devices 150a-105n may be smartphones or PCs of the bank customers. Each smartphone or PC may run a banking application distributed by and in communication with the bank's central server 125. The banking application may collect customers'account information to be stored in a corresponding distributed database 203a-203n. The banking application may train the distributed models 215a-215n with the collected customers'account information. The banking application may transmit the collected customers'account information to the central database 304. The banking application may receive instructions from the central server 125. The instructions may include decisions uniquely made for the edge device (105a-105n) by the federated model 225 based on the edge device (105a-105n) collected customer's account information.

FIG. 4 is a block diagram illustrating an AI-based banking system 400 for making discrete decisions catered to individual customers in accordance with at least some embodiments of the present disclosure. At a heart of the banking system 400 may be an AI model 402. In some embodiments, the AI model 402 may represent one of the distributed models 215a-215n shown in FIG. 3 and reside in one of the edge devices 105a-105n shown in FIG. 1. Inputs to the AI model 402 may exemplarily include a particular customer's spend/payoff history 412, bureau report 414, reward usage 416 and other data 418. These inputs in general represent the customer's risk of defaulting the bank. Outputs from the AI model may exemplarily include individual reward rate 423 and credit limit adjustment 427 determined by the AI model 402 based on the inputs. These outputs in general represent the bank's actions that may reduce the customer's default risk.

In some embodiments, the AI model 402 may generate a customer-specific reward rate based on individual customer's risk. For example, the AI model 402 may decide to pay a 0.5% reward rate to a customer now in lieu of increasing a credit limit to lower a risk that the customer balance must be charged off. This may be to swap future liability of potential charge offs by altering reward rates for customers today.

In some embodiments, the AI model 402 may dynamically adjust customer reward rate and conversion rate (points to cash conversion) to encourage the customers to use their credit cards and pay them off on time. For example, a credit card may have a small starting reward rate, if the credit card may be highly used and maintains a low balance, the reward rate may increase.

In some embodiments, the AI model 402 may target a particular behavior. For example, the AI model 402 may exemplarily generate an incentive or a telephone notice in response to a customer's balance approaching his/her credit limits. As another example, a notice may be generated in response to approaching a due date.

In some embodiments, the AI model 402 may target to change a customer's spending habits to be more fiscally responsible. For example, spendings in grocery stores may receive a higher reward rate than spendings in restaurants.

In some embodiments, the AI model 402 may frequently, such as every couple of days, change the reward rates so that comparing one customer's reward rate with another's becomes difficult. Such frequent changes may be controlled by special rules inside the AI model 402 in addition to the dynamic inputs 412-418 as shown in FIG. 4. In some embodiments, the change frequency may be subject to learning, and may be dynamically determined.

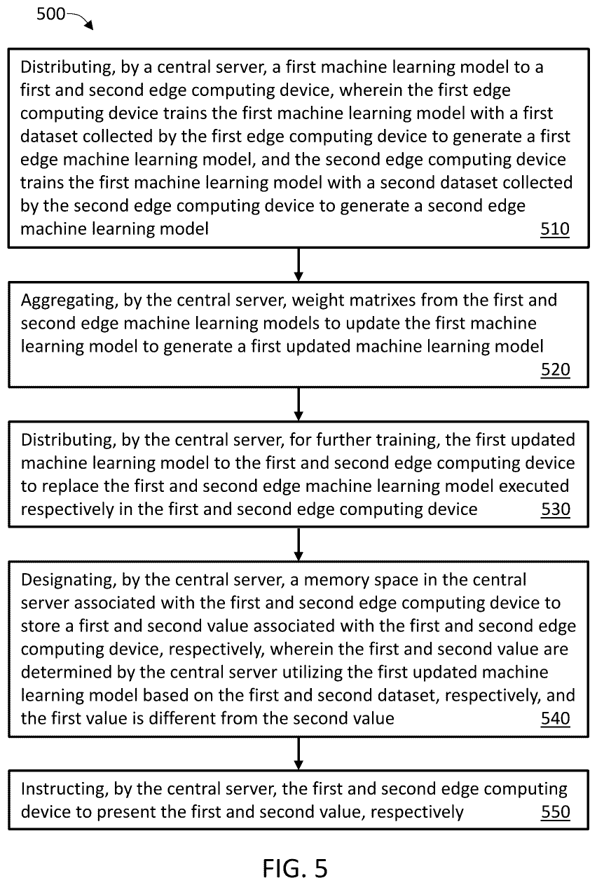

FIG. 5 is a flowchart illustrating an exemplary process 500 for making discrete decisions for individual edge computing devices in accordance with at least some embodiments of the present disclosure. The process 500 begins with block 510 by distributing, by a central server, a first machine learning model to a first and second edge computing device, where the first edge computing device trains the first machine learning model with a first dataset collected by the first edge computing device to generate a first edge machine learning model, and the second edge computing device trains the first machine learning model with a second dataset collected by the second edge computing device to generate a second edge machine learning model. In some embodiments, the central server may be represented the central server 125 shown in FIG. 1; the first and second edge computing device may be among the edge device 105a-105n shown in FIG. 1; the first and second dataset may include data 412-418 shown in FIG. 4 and may be stored either separately in the distributed databases 203a-203n shown in FIG. 2 or in the central database 304 shown in FIG. 3; and the first machine learning model and the first edge machine learning model may be represented by distributed models 215a-215n before and after a training.

In block 520, the process 500 aggregates, by the central server, weight matrices from the first and second edge machine learning models to update the first machine learning model to generate a first updated machine learning model. In some embodiments, the first updated machine learning model may be represented by the federated model 225 shown in FIGS. 2 and 3.

In block 530, the process 500 distributes, by the central server, for further training, the first updated machine learning model to the first and second edge computing device to replace the first and second edge machine learning model executed respectively in the first and second edge computing device.

In block 540, the process 500 designates, by the central server, a memory space in the central server associated with the first and second edge computing device to store a first and second value associated with the first and second edge computing device, respectively, where the first and second value are determined by the central server utilizing the first updated machine learning model based on the first and second dataset, respectively, and the first value may be different from the second value. In some embodiments, the first and second value may be represented by the individual reward rate 423 shown in FIG. 4.

In block 550, the process 500 instructs, by the central server, the first and second edge computing device to present the first and second value, respectively. In some embodiments, the first and second value are displayed by the first and second edge computing device, respectively.

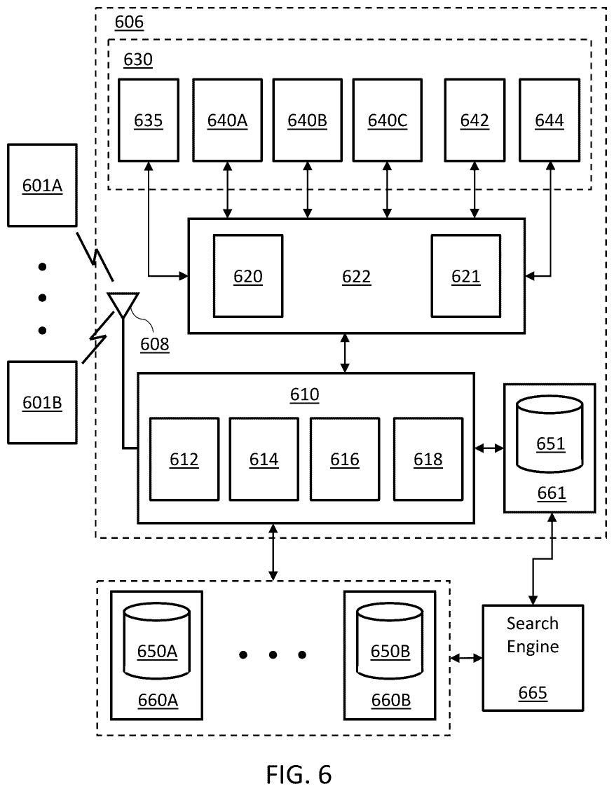

FIG. 6 is a block diagram of a computing system 600 for implementing the processes depicted in FIG. 1-5 in accordance with at least some embodiments of the present disclosure. Aspects of the present disclosure may be applied to an exemplary real-time entity-resolution (RTER) microservices platform 606 that may include RTER software modules denoted 635, 640A, 640B, and 640C for implementing the RTER microservices in a service layer 630 as described hereinbelow. At least one search query generator software module 642 may be configured to generate search queries in response to an entity-specific data request for entity-specific data from a user via a graphical user interface (GUI).

In at least some embodiments, or in combination with at least one other embodiment described herein, the RTER microservices platform 606 may include a multi-layered architecture including, for example, the service layer 630, an orchestration layer 622, and a platform layer 610, however other layers may be additionally contemplated. In some embodiments, a plurality of users may interact with the RTER microservices platform 606 via any of N user devices denoted 601A . . . 601B, where N may be an integer. The N user devices denoted 601A . . . 601B may include the GUI for any number of users to interact with the RTER microservices platform 606. FIG. 6 shows the first user device 601A and the Nth user device 601B. Communications from the user devices 601A . . . 601B may be received by a transceiver 608 and may then be routed to an appropriate component of the system, via the platform layer 610, for example.

In at least some embodiments, or in combination of at least one other embodiment described herein, the platform layer 610 may include an input/output (I/O) interface 612 for facilitating data communication to external devices, such as, e.g., the transceiver 608 with any other system devices. The platform layer 610 may also include a runtime environment 614 for implementing programs, services, functionalities and microservices using a plurality of processors 616 and memory devices 618 for implementing the RTER microservices platform 606. The memory devices 618 may include, e.g., temporary storage and caching of data to facilitate resources of the RTER microservices platform 606. In some embodiments, the platform layer 610 includes functionality for, e.g., configuration management, logging and monitoring of data traffic, document management, communication routing, notifications, messaging tools, reporting tools, as well as any other functions pertaining to platform level functionality.

In at least some embodiments, or in combination of at least one other embodiment described herein, a request from any of the user devices 601A and 601B may be routed to an orchestrator 620 in the orchestration layer 622. In other embodiments, the orchestrator 620 may manage operations of the RTER microservices platform 606, including allocation of resources, process schedule with, e.g., the plurality of processors 616, among other tasks. For example, in some embodiments, the orchestrator 620 may include a plurality of application programming interfaces (APIs) 621 for calling services and functions of the RTER microservices platform 606 in interacting with the user devices 601A . . . 601B.

In at least some embodiments, or in combination of at least one other embodiment described herein, the orchestrator 620 may manage operations of microservices in a service layer 630 and coordination of the service layer 630 with the platform layer 610. For example, the service layer 630 may include software modules 635, 640A, 640B, and 640C related to, for example, implementing the RTER microservices platform 606 and the at least one search query generator software module 642 to generate search queries for the search engine 665. In some embodiments, the orchestrator 620 may facilitate aggregation of data from multiple domains in the service layer 630 and/or may orchestrate data-related operations across domains and services to provide for complete experiences within any given domain.

In at least some embodiments, or in combination of at least one other embodiment described herein, the service layer 630 may also include at least one shared microservice 644 that may include functionality that may be shared across multiple domains.

In at least some embodiments, or in combination of at least one other embodiment described herein, the orchestrator 620 may manage the data flow and the execution of microservices such that data may be shared, processed, and returned to any of the N user devices 601A . . . 601B. For example, a user device such as the user device 601A may communicate a request, e.g., a user interaction via a GUI of the user device 601A. The request may be received by the transceiver 608 and routed via the platform layer 610 to the orchestrator 620. A search request may be entered by the user into the GUI on a particular user device from any of the N user devices 601A . . . 601B and the search results may be displayed in the GUI of the particular user device for the user to analyze.

In at least some embodiments, or in combination of at least one other embodiment described herein, the computing system 600 may include a plurality of M electronic resources denoted 660A . . . 660B on which a plurality of M databases may be stored and respectively denoted as 650A . . . 650B where M may be an integer. An additional electronic resource 661 may include an entity profile database 651. The plurality of M electronic resources 660A . . . 660B and the additional electronic resource 661 may be communicatively coupled to the RTER microservices platform 606.

In at least some embodiments, or in combination of at least one other embodiment described herein, the plurality of M databases 650A . . . 650B may include the entity profile database 651. In other embodiments, the entity profile database 651 may be separate from the plurality of M databases 650A . . . 650B. In yet other embodiments, the entity profile database 651 may be separate from, but communicatively coupled to the plurality of M databases 650A . . . 650B.

In at least some embodiments, or in combination of at least one other embodiment described herein, the RTER microservices platform 606 may be communicatively coupled to send and receive data to a search engine 665.

In at least some embodiments, or in combination of at least one other embodiment described herein, the plurality of M electronic resources 660A . . . 660B and the additional electronic resource 661 may be communicatively coupled with the search engine 665.

In at least some embodiments, or in combination of at least one other embodiment described herein, the search engine 665 may be an Elasticsearch search engine. The Elasticsearch search engine may be based on a Lucene library. It may be a distributed, multitenant-capable full-text search engine with a HTTP web interface and schema-free JSON documents.

In at least some embodiments, or in combination of at least one other embodiment described herein, any data stored on any of the plurality of databases 650A . . . 650B, such as entity-specific data associated with any of a plurality of entities may be accessible from the N user devices 601A . . . 601B via any of the plurality of APIs in the orchestrator 620 in the RTER microservices platform 606. User access may require proper user access authentication.

In at least some embodiments, or in combination of at least one other embodiment described herein, each of plurality of M electronic resources (ER) denoted 660A . . . 660B may include at least one ER processor and/or ER controller, ER input and/or ER output devices, and/or ER communication circuitry for communicating over a communication network with any of the elements and/or devices in the computing system 600. API calls via any of the plurality of APIs 621 to the at least ER processor and/or ER controller may be programmed to search for and/or process entity-specific data stored in any of the plurality of M databases.

In at least some embodiments, or in combination of at least one other embodiment described herein, for efficient processing of initial business data for generating the ElasticSearch search query, API calls to an entity profile database 651 stored in an electronic resource 661 may include data-reducing hashing functions to reduce the size of the initial business data for a particular business that may be returned to the microservice as compress data. The entity-specific data in the entity profile database 651 may then be decompressed by the original hash function and/or by algorithms based on the hash function used in the original API calls. Moreover, the hash function algorithms may cluster business data features from the compressed data. These clustered features may be used by the algorithms to generate an ElasticSearch query that streamlines the search coverage.

In at least some embodiments, or in combination of at least one other embodiment described herein, the entity profile database 651 from the plurality of M databases 650A . . . 650B may be stored on the electronic resource 661 from the plurality of electronic resources coupled to the microservice RTER platform 606 and/or may require authentication to access.

In at least some embodiments, or in combination of at least one other embodiment described herein, the entity profile database 651 may be separate from the plurality of M databases 650A . . . 150B and may be directly accessible from the microservice RTER platform 606 as shown in FIG. 6.

In at least some embodiments, or in combination of at least one other embodiment described herein, the first exemplary flow for managing the search engine results may further include the orchestrator 620 may join the blocking module 640A output and the scoring module 640C output and may transmit all of the matching pairs, their matching scores, entity (business) firmographics, and/or transaction data to the user on one of the N user devices 601A . . . 101B.

In at least some embodiments, or in combination of at least one other embodiment described herein, a second exemplary flow for managing the search engine results may further include all of the functionality of the featurizer module 640B, and/or the scoring module 640C as described herein above. However, to more efficiently manage the search engine results before receiving the search results, the at least one search query generator software module 642 may include an algorithm to take the data in the entity-specific data request to generate the entity-specific database query request that may be crafted to reduce extraneous search results hits.

In at least some embodiments, or in combination of at least one other embodiment described herein, the entity resolution microservice platform 606 may update at least one entity profile in the entity profile database 651 for the at least one entity with the additional entity-specific data.

In at least some embodiments, or in combination of at least one other embodiment described herein, the at least one entity may be a business. The at least one entity profile may be a profile of the business. The entity-specific data may include business data from the search engine associated with the business. Thus, the entity resolution microservice platform 606 may update the profile of the business with the business data received from the search engine 665.

In at least some embodiments, or in combination of at least one other embodiment described herein, the entity resolution microservice platform 606 may receive the search engine results data comprising entity-specific data records. Each entity-specific data record may include a matching score. In other embodiments, the scoring module 640C may generate the matching score. The matching score may be indicative of a match between the entity-specific data in each entity-specific data record and the entity-specific data in the entity-specific database query request associated with the at least one entity.

For example, the previous example described hereinabove illustrates the scoring module 640C assigning a matching score to each of the search results for the entity name in the entity-specific data based on the entity name (e.g., Entity Name 1s) in the entity-specific data request. However, the types of entity specific data are not limited to the entity name, but may also include the entity owner, the entity address etc. The search results may include search hits for each type of entity-specific data in the entity-specific data request that are each scored within each respective type of entity specific data. The search engine may receive search results hits for the different types of entity-specific data, each receiving a matching score. The search results hits for the different types of entity-specific data may be unordered.

In at least some embodiments, or in combination of at least one other embodiment described herein, the entity resolution microservice platform 606 may perform an ordering of the entity-specific data for each type from a highest matching score to a lowest matching score and to store a secondary file of the search engine results data with entity-specific data records having a predefined number of highest matching scores. The secondary file may include the entity-specific data with the highest matching score for each given type so as to capture, for example, the search hit with the highest matching score for each type (e.g., the entity name, entity address, entity owner name, and the like).

In at least some embodiments, or in combination of at least one other embodiment described herein, the predefined number of highest matching scores may include 40 search engine results with the highest matching scores. The predefined number of highest matching scores may include 400 search engine results with the highest matching scores. The predefined number of highest matching scores may include 500 search engine results with the highest matching scores. The predefined number of highest matching scores may include 4000 search engine results with the highest matching scores. The predefined number of highest matching scores may include 5000 search engine results with the highest matching scores. The predefined number of highest matching scores may include 40,000 search engine results with the highest matching scores.

In at least some embodiments, or in combination of at least one other embodiment described herein, the entity resolution microservice platform 606 may generate an index for each entity-specific data record in the secondary file since the search results hits for the different types of entity-specific data may be unordered.

In at least some embodiments, or in combination of at least one other embodiment described herein, the entity resolution microservice platform 606 may apply the same index during another search to the search engine results data for the entity-specific data associated with the at least one entity in response to another entity-specific data request that generates another entity-specific database query request for the search engine identical to the entity-specific database query request. (Note that the indexing may be applied to either of the first and second exemplary flows or both for managing the search results.)

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment may be implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In at least some embodiments, or in combination of at least one other embodiment described herein, one or more of exemplary inventive computer-based systems/platforms, exemplary inventive computer-based devices, and/or exemplary inventive computer-based components of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In at least some embodiments, or in combination of at least one other embodiment described herein, as detailed herein, one or more of exemplary inventive computer-based systems/platforms, exemplary inventive computer-based devices, and/or exemplary inventive computer-based components of the present disclosure may be implemented across one or more of various computer platforms such as, but not limited to: (1) FreeBSD, NetBSD, OpenBSD; (2) Linux; (3) Microsoft Windows; (4) OS X (MacOS); (5) MacOS 41; (6) Solaris; (7) Android; (8) iOS; (9) Embedded Linux; (10) Tizen; (11) WebOS; (12) IBM i; (13) IBM AIX; (14) Binary Runtime Environment for Wireless (BREW); (15) Cocoa (API); (16) Cocoa Touch; (17) Java Platforms; (18) JavaFX; (19) JavaFX Mobile; (20) Microsoft DirectX; (21). NET Framework; (22) Silverlight; (23) Open Web Platform; (24) Oracle Database; (25) Qt; (26) Eclipse Rich Client Platform; (27) SAP NetWeaver; (28) Smartface; and/or (29) Windows Runtime.

In at least some embodiments, or in combination of at least one other embodiment described herein, exemplary inventive computer-based systems/platforms, exemplary inventive computer-based devices, and/or exemplary inventive computer-based components of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

As used herein, the terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In at least some embodiments, or in combination of at least one other embodiment described herein, the exemplary inventive computer-based systems/platforms, the exemplary inventive computer-based devices, and/or the exemplary inventive computer-based components of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTR0, SHA-1, SHA-2, Tiger (TTH), WHIRLPOOL, RNGs).

The aforementioned examples are, of course, illustrative and not restrictive.

As used herein, the term “user” shall have a meaning of at least one user. In some embodiments, the terms “user”, “subscriber” “consumer” or “customer” should be understood to refer to a user of an application or applications for implementing the functions of the CVCP as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

In at least some embodiments, or in combination of at least one other embodiment described herein, exemplary inventive computer-based systems/platforms, exemplary inventive computer-based devices, and/or exemplary inventive computer-based components of the present disclosure may be configured to handle numerous concurrent users via the N user devices 601A and 601B that may be, but is not limited to, at least 400 (e.g., but not limited to, 400-999), at least 4,000 (e.g., but not limited to, 4,000-9,999) , at least 40,000 (e.g., but not limited to, 40,000-99,999), at least 400,000 (e.g., but not limited to, 400,000-999,999), at least 4,000,000 (e.g., but not limited to, 4,000,000-9,999,999), at least 40,000,000 (e.g., but not limited to, 40,000,000-99,999,999), at least 400,000,000 (e.g., but not limited to, 400,000,000-999,999,999), at least 4,000,000,000 (e.g., but not limited to, 4,000,000,000-999,999,999,999), and so on.

In at least some embodiments, or in combination of at least one other embodiment described herein, the illustrative computing devices and the illustrative computing components of the exemplary computer-based system 600 and platform 606 may be configured to manage a large number of members and concurrent transactions, as detailed herein. In some embodiments, the exemplary computer-based system 600 and platform 606 may be based on a scalable computer and network architecture that incorporates various strategies for assessing the data, caching, searching, and/or database connection pooling.

In at least some embodiments, or in combination of at least one other embodiment described herein, the N client (user) devices 601A through 601B may be personal computers, multiprocessor systems, microprocessor-based or programmable consumer electronics, network PCs, and the like. In some embodiments, one or more client devices within the N client devices 601A through 601B may include computing devices that typically connect using a wireless communications medium such as cell phones, smart phones, pagers, walkie talkies, radio frequency (RF) devices, infrared (IR) devices, citizens band radio, integrated devices combining one or more of the preceding devices, or virtually any mobile computing device, and the like. In some embodiments, one or more client devices within client devices !02 through !04 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that may be equipped to communicate over a wired and/or wireless communication medium (e.g., NFC, RFID, NBIOT, 3G, 4G, 5G, GSM, GPRS, WiFi, WiMax, CDMA, OFDM, OFDMA, LTE, satellite, ZigBee, etc.).

In at least some embodiments, or in combination of at least one other embodiment described herein, one or more client devices within the N client devices 601A through 601B may include may run one or more applications, such as Internet browsers, mobile applications, voice calls, video games, videoconferencing, and email, among others. In some embodiments, one or more client devices within the N client devices 601A through 601B may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a client device within client devices 602 through 604 may be specifically programmed by either Java, .Net, QT, C, C++, Python, PHP and/or other suitable programming language. In some embodiment of the device software, device control may be distributed between multiple standalone applications. In some embodiments, software components/applications can be updated and redeployed remotely as individual units or as a full software suite. In some embodiments, a client device may periodically report status or send alerts over text or email. In some embodiments, a client device may contain a data recorder which may be remotely downloadable by the user using network protocols such as FTP, SSH, or other file transfer mechanisms. In some embodiments, a client device may provide several levels of user interface, for example, advanced user, standard user. In some embodiments, one or more client devices within the N client devices 601A through 601B may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments and, optionally, in combination of any embodiment described above or below, for example, the N client devices 601A through 601B, and/or the exemplary platform 606 may include a specifically programmed software module in the service layer 630 that may be configured to send, process, and receive information using a scripting language, a remote procedure call, an email, a tweet, Short Message Service (SMS), Multimedia Message Service (MMS), instant messaging (IM), an application programming interface, Simple Object Access Protocol (SOAP) methods, Common Object Request Broker Architecture (CORBA), HTTP (Hypertext Transfer Protocol), REST (Representational State Transfer), SOAP (Simple Object Transfer Protocol), MLLP (Minimum Lower Layer Protocol), or any combination thereof.

In at least some embodiments, or in combination of at least one other embodiment described herein, the N client devices 601A through 601B as well as the I/O devices in the platform layer 610 may also include a number of external or internal devices such as a mouse, a CD-ROM, DVD, a physical or virtual keyboard, a display, or other input or output devices. In some embodiments, examples of the N client devices 601A through 601B as well as devices in the platform layer 610 may be any type of processor-based platforms that are connected to a network such as, without limitation, personal computers, digital assistants, personal digital assistants, smart phones, pagers, digital tablets, laptop computers, Internet appliances, and other processor-based devices. In some embodiments, client devices 601A through 601B may be specifically programmed with one or more application programs in accordance with one or more principles/methodologies detailed herein. In some embodiments, the N client devices 601A through 601B as well as devices in the platform layer 610 may operate on any operating system capable of supporting a browser or browser-enabled application, such as Microsoft™, Windows™, and/or Linux. In some embodiments, the N client devices 601A through 601B as well as devices in the platform layer 610 shown may include, for example, personal computers executing a browser application program such as Microsoft Corporation's Internet Explorer™, Apple Computer, Inc.'s Safari™, Mozilla Firefox, and/or Opera.

In at least some embodiments, or in combination with at least one other embodiment described herein, at least one database of M exemplary databases 650A . . . 150B may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that may be stored.

In at least some embodiments, or in combination of at least one other embodiment described herein, the exemplary inventive computer-based systems/platforms, the exemplary inventive computer-based devices, and/or the exemplary inventive computer-based components of the present disclosure may be specifically configured to operate in a cloud computing/architecture such as, but not limiting to: infrastructure a service (IaaS), platform as a service (PaaS), and/or software as a service (SaaS) using a web browser, mobile app, thin client, terminal emulator or other endpoint.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

As used herein, the term “runtime” corresponds to any behavior that may be dynamically determined during an execution of a software application or at least a portion of a software application.

In at least some embodiments, or in combination of at least one other embodiment described herein, exemplary inventive, specially programmed computing systems and platforms with associated devices are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk(™), TCP/IP (e.g., HTTP), near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

As used herein, terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

As used herein, the term “user” shall have a meaning of at least one user. In some embodiments, the terms “user”, “subscriber” “consumer” or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session or can refer to an automated software application which receives the data and stores or processes the data.

The aforementioned examples are, of course, illustrative and not restrictive.

In at least some embodiments, or in combination of at least one other embodiment described herein, the exemplary inventive computer-based systems/platforms, the exemplary inventive computer-based devices, and/or the exemplary inventive computer-based components of the present disclosure such as for example, the scoring module 640C, may be configured to utilize one or more exemplary AI/machine-learning techniques chosen from, but not limited to, decision trees, boosting, support-vector machines, neural networks, nearest neighbor algorithms, Naive Bayes, bagging, random forests, and the like. In some embodiments and, optionally, in combination of any embodiment described above or below, an exemplary neutral network technique may be one of, without limitation, feedforward neural network, radial basis function network, recurrent neural network, convolutional network (e.g., U-net) or other suitable network. In some embodiments and, optionally, in combination of any embodiment described above or below, an exemplary implementation of Neural Network may be executed as follows:
i) Define Neural Network architecture/model,
ii) Transfer the input data to the exemplary neural network model,
iii) Train the exemplary model incrementally,
iv) determine the accuracy for a specific number of timesteps,
v) apply the exemplary trained model to process the newly-received input data,
vi) optionally and in parallel, continue to train the exemplary trained model with a predetermined periodicity.

In some embodiments and, optionally, in combination of any embodiment described above or below, the exemplary trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the exemplary trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node may be activated. In some embodiments and, optionally, in combination of any embodiment described above or below, the exemplary aggregation function may be a mathematical function that combines (e.g., sum, product, etc.) input signals to the node. In some embodiments and, optionally, in combination of any embodiment described above or below, an output of the exemplary aggregation function may be used as input to the exemplary activation function. In some embodiments and, optionally, in combination of any embodiment described above or below, the bias may be a constant value or function that may be used by the aggregation function and/or the activation function to make the node more or less likely to be activated.

At least some aspects of the present disclosure will now be described with reference to the following numbered clauses.

Clause 1. A computer-implemented method, comprising: distributing, by a central server, a first machine learning model to a first and second edge computing device, where the first edge computing device trains the first machine learning model with a first dataset collected by the first edge computing device to generate a first edge machine learning model, and the second edge computing device trains the first machine learning model with a second dataset collected by the second edge computing device to generate a second edge machine learning model; updating, by the central server aggregating with at least one weight matrix reflecting the first and second edge machine learning model, the first machine learning model to generate a first updated machine learning model; distributing, by the central server, for further training, the first updated machine learning model to the first and second edge computing device to replace the first and second edge machine learning model executed respectively in the first and second edge computing device; designating, by the central server, a memory space in the central server associated with the first and second edge computing device to store a first and second value associated with the first and second edge computing device, respectively, where the first and second value are determined by the central server utilizing the first updated machine learning model based on the first and second dataset, respectively, and the first value is different from the second value; and instructing, by the central server, the first and second edge computing device to present the first and second value, respectively.

Clause 2. The method of clause 1, where the first dataset is stored in the first edge computing device and the second dataset is stored in the second edge computing device.

Clause 3. The method of clause 1, where the first and second dataset have same features.

Clause 4. The method of clause 3, where the features comprise a spend history, bureau report and reward usage of a user of the first or second edge computing device.

Clause 5. The method of clause 1, where the first edge computing device is associated with at least one first hyperparameter used for training the first machine learning model to generate the first edge machine learning model, and the second edge computing device is associated with at least one second hyperparameter different from the at least one first hyperparameter for training the first machine learning model to generate the second edge machine learning model.

Clause 6. The method of clause 1, where the first machine learning model is updated at a predetermined frequency.

Clause 7. The method of clause 1, where the first edge computing device collects a third dataset after presenting the first value and further trains the first updated machine learning model with the third dataset.

Clause 8. The method of clause 1, further comprising condensing the first updated machine learning model before distributing the first updated machine learning model.

Clause 9. The method of clause 1, where the first and second edge machine learning model are weighted equally.

Clause 10. The method of clause 1, where the first and second edge machine learning model are weighted differently based on attributes associated with the first and second edge computing device.

Clause 11. A computer-implemented method, comprising: distributing, by a central server, a first machine learning model to a first and second edge computing device, where the first edge computing device trains the first machine learning model with a first dataset stored in the first edge computing device to generate a first edge machine learning model, and the second edge computing device trains the first machine learning model with a second dataset stored in the second edge computing device to generate a second edge machine learning model, where the first and second dataset have same features; updating, by the central server aggregating with at least one weight matrix reflecting the first and second edge machine learning model, the first machine learning model to generate a first updated machine learning model; distributing, by the central server, for further training, the first updated machine learning model to the first and second edge computing device to replace the first and second edge machine learning model executed respectively in the first and second edge computing device; designating, by the central server, a memory space in the central server associated with the first and second edge computing device to store a first and second value associated with the first and second edge computing device, respectively, where the first and second value are determined by the central server utilizing the first updated machine learning model based on the first and second dataset, respectively, and the first value is different from the second value; and instructing, by the central server, the first and second edge computing device to present the first and second value, respectively.

Clause 12. The method of clause 11, where the first edge computing device is associated with at least one first hyperparameter used for training the first machine learning model to generate the first edge machine learning model, and the second edge computing device is associated with at least one second hyperparameter different from the at least one first hyperparameter for training the first machine learning model to generate the second edge machine learning model.

Clause 13. The method of clause 11, further comprising condensing the first updated machine learning model before distributing the first updated machine learning model.

Clause 14. A system, comprising: at least one central server; and at least one memory storing a plurality of computing instructions configured to instruct the at least one central server to: distribute a first machine learning model to a first and second edge computing device, where the first edge computing device trains the first machine learning model with a first dataset collected by the first edge computing device to generate a first edge machine learning model, and the second edge computing device trains the first machine learning model with a second dataset collected by the second edge computing device to generate a second edge machine learning model; update, by aggregating with at least one weight matrix reflecting the first and second edge machine learning model, the first machine learning model to generate a first updated machine learning model; distribute, for further training, the first updated machine learning model to the first and second edge computing device to replace the first and second edge machine learning model executed respectively in the first and second edge computing device; designate a memory space in the central server associated with the first and second edge computing device to store a first and second value associated with the first and second edge computing device, respectively, where the first and second value are determined by the central server utilizing the first updated machine learning model based on the first and second dataset, respectively, and the first value is different from the second value; and instruct the first and second edge computing device to present the first and second value, respectively.

Clause 15. The system of clause 14, where the first dataset is stored in the first edge computing device and the second dataset is stored in the second edge computing device.

Clause 16. The system of clause 14, where the first and second dataset have same features.

Clause 17. The system of clause 14, where the first edge computing device is associated with at least one first hyperparameter used for training the first machine learning model to generate the first edge machine learning model, and the second edge computing device is associated with at least one second hyperparameter different from the at least one first hyperparameter for training the first machine learning model to generate the second edge machine learning model.

Clause 18. The system of clause 14, where the first machine learning model is updated at a predetermined frequency.

Clause 19. The system of clause 14, where the plurality of computing instructions are further configured to instruct the at least one central server to condense the first updated machine learning model before distributing the first updated machine learning model.

Clause 20. The system of clause 14, where the first and second edge machine learning model are weighted equally.

Publications cited throughout this document are hereby incorporated by reference in their entirety. While one or more embodiments of the present disclosure have been described, it may be understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added and/or any desired steps may be eliminated).

1. A computer-implemented method, comprising:
distributing, by a central server, a first machine learning model to a first and second edge computing device, wherein the first edge computing device trains the first machine learning model with a first dataset collected by the first edge computing device to generate a first edge machine learning model, and the second edge computing device trains the first machine learning model with a second dataset collected by the second edge computing device to generate a second edge machine learning model;
updating, by the central server aggregating with at least one weight matrix reflecting the first and second edge machine learning model, the first machine learning model to generate a first updated machine learning model;
distributing, by the central server, for further training, the first updated machine learning model to the first and second edge computing device to replace the first and second edge machine learning model executed respectively in the first and second edge computing device;
designating, by the central server, a memory space in the central server associated with the first and second edge computing device to store a first and second value associated with the first and second edge computing device, respectively, wherein the first and second value are determined by the central server utilizing the first updated machine learning model based on the first and second dataset, respectively, and the first value is different from the second value; and
instructing, by the central server, the first and second edge computing device to present the first and second value, respectively.

2. The method of claim 1, wherein the first dataset is stored in the first edge computing device and the second dataset is stored in the second edge computing device.

3. The method of claim 1, wherein the first and second dataset have same features.

4. The method of claim 3, wherein the features comprise spend history, bureau report and reward usage of a user of the first or second edge computing device.

5. The method of claim 1, wherein the first edge computing device is associated with at least one first hyperparameter used for training the first machine learning model to generate the first edge machine learning model, and the second edge computing device is associated with at least one second hyperparameter different from the at least one first hyperparameter for training the first machine learning model to generate the second edge machine learning model.

6. The method of claim 1, wherein the first machine learning model is updated at a predetermined frequency.

7. The method of claim 1, wherein the first edge computing device collects a third dataset after presenting the first value and further trains the first updated machine learning model with the third dataset.

8. The method of claim 1, further comprising condensing the first updated machine learning model before distributing the first updated machine learning model.

9. The method of claim 1, wherein the first and second edge machine learning model are weighted equally.

10. The method of claim 1, wherein the first and second edge machine learning model are weighted differently based on attributes associated with the first and second edge computing device.

11. A computer-implemented method, comprising:
distributing, by a central server, a first machine learning model to a first and second edge computing device, wherein the first edge computing device trains the first machine learning model with a first dataset stored in the first edge computing device to generate a first edge machine learning model, and the second edge computing device trains the first machine learning model with a second dataset stored in the second edge computing device to generate a second edge machine learning model, wherein the first and second dataset have same features;
updating, by the central server aggregating with at least one weight matrix reflecting the first and second edge machine learning model, the first machine learning model to generate a first updated machine learning model;
distributing, by the central server, for further training, the first updated machine learning model to the first and second edge computing device to replace the first and second edge machine learning model executed respectively in the first and second edge computing device;
designating, by the central server, a memory space in the central server associated with the first and second edge computing device to store a first and second value associated with the first and second edge computing device, respectively, wherein the first and second value are determined by the central server utilizing the first updated machine learning model based on the first and second dataset, respectively, and the first value is different from the second value; and
instructing, by the central server, the first and second edge computing device to present the first and second value, respectively.

12. The method of claim 11, wherein the first edge computing device is associated with at least one first hyperparameter used for training the first machine learning model to generate the first edge machine learning model, and the second edge computing device is associated with at least one second hyperparameter different from the at least one first hyperparameter for training the first machine learning model to generate the second edge machine learning model.

13. The method of claim 11, further comprising condensing the first updated machine learning model before distributing the first updated machine learning model.

14. A system, comprising:
at least one central server; and
at least one memory storing a plurality of computing instructions configured to instruct the at least one central server to:
distribute a first machine learning model to a first and second edge computing device, wherein the first edge computing device trains the first machine learning model with a first dataset collected by the first edge computing device to generate a first edge machine learning model, and the second edge computing device trains the first machine learning model with a second dataset collected by the second edge computing device to generate a second edge machine learning model;
update, by aggregating with at least one weight matrix reflecting the first and second edge machine learning model, the first machine learning model to generate a first updated machine learning model;
distribute, for further training, the first updated machine learning model to the first and second edge computing device to replace the first and second edge machine learning model executed respectively in the first and second edge computing device;
designate a memory space in the central server associated with the first and second edge computing device to store a first and second value associated with the first and second edge computing device, respectively, wherein the first and second value are determined by the central server utilizing the first updated machine learning model based on the first and second dataset, respectively, and the first value is different from the second value; and
instruct the first and second edge computing device to present the first and second value, respectively.

15. The system of claim 14, wherein the first dataset is stored in the first edge computing device and the second dataset is stored in the second edge computing device.

16. The system of claim 14, wherein the first and second dataset have same features.

17. The system of claim 14, wherein the first edge computing device is associated with at least one first hyperparameter used for training the first machine learning model to generate the first edge machine learning model, and the second edge computing device is associated with at least one second hyperparameter different from the at least one first hyperparameter for training the first machine learning model to generate the second edge machine learning model.

18. The system of claim 14, wherein the first machine learning model is updated at a predetermined frequency.

19. The system of claim 14, wherein the plurality of computing instructions are further configured to instruct the at least one central server to condense the first updated machine learning model before distributing the first updated machine learning model.

20. The system of claim 14, wherein the first and second edge machine learning model are weighted equally.
